(19) United States
(12) Patent Application Publication
(10) Pub. No.: US 2016/0332190 A1
(43) Pub. Date: Nov. 17, 2016

(54) METHOD OF PRODUCING SILICA NANOSTRUCTURE

(71) Applicant: SOOKMYUNG WOMEN'S UNIVERSITY INDUSTRY ACADEMIC COOPERATION, SEOUL (KR)

(72) Inventors: Jin Seok Lee, Seoul (KR); Seo Young Yoon, Gyeonggi-do (KR); Yi Seul Park, Seoul (KR)

(21) Appl. No.: 15/154,607

(22) Filed: May 13, 2016

(30) Foreign Application Priority Data
May 15, 2015 (KR) 10-2015-0068291

(51) Int. Cl. B05D 1/00

(52) U.S. Cl. CPC B05D 1/005

(57) ABSTRACT

A method of producing silica nanostructures, and more particularly, to a method of producing silica nanostructures is described to easily control shapes of the nanostructures produced with even using liquid phase deposition(LPD), so that the nanostructures can be applied to a circuit or a transistor using a dielectric material and can be applied to a large area, resulting in promising applicability to industries. The method includes method of producing silica nanostructures, the method comprising performing low-temperature liquid phase deposition (LPD) including adding silica to a liquid phase deposition (LPD) solution and impregnating silica beads in the silica-added LPD solution, wherein shapes of the silica nanostructures are controlled by adjusting the concentration of silica based on the following expression:

0<W_{F}≦W_{S} (1)

where W_{F} is the content of silica added, and W_{S} is the content of silica required for the LPD solution to be saturated.

### CROSS-REFERENCE TO RELATED APPLICATION

This application claims priority to and the benefit of Korean Patent Application No. 10-2015-0068291 filed on May 15, 2015 in the Korean Intellectual Property Office, and all the benefits accruing therefrom under 35 U.S.C. 119, the contents of which in its entirety are herein incorporated by reference.

### BACKGROUND

1. Field

The present invention relates to a method of producing silica nanostructures, and more particularly, to a method of producing silica nanostructures to easily control shapes of the nanostructures produced with even using liquid phase deposition(LPD), so that the nanostructures can be applied to a circuit or a transistor using a dielectric material and can be applied to a large area, resulting in promising applicability to industries.

2. Description of the Related Art

Conventional deposition methods of dielectric materials, including electrochemical deposition, vapor deposition, organometallic deposition using sensitive organometallic reactants, and so on, are disadvantageous due to complicated reactor systems or deposition conditioning difficulties. Alternative deposition methods of dielectric materials may include chemical vapor deposition, sputtering, and so on, which are advantageous in obtaining uniform films but are disadvantageous due to a high-temperature reaction condition.

A silicon dioxide (SiO₂) film is one of most typically used dielectric materials, and can be applied to various fields, such as ultra large scale integration (ULSI) technology, fabrication of an integrated circuit (IC), or formation of a gate oxide or an interlayer dielectric for a transistor. In addition, the SiO₂ film could potentially be applied as one of the chief components of optical antireflection coatings and liquid crystal display (LCD) substrates as a mask to prevent alkali ions from diffusing to the indium tin oxide (ITO) films.

However, the LPD research to date has faced several difficulties in controlling the shape of a nanostructure.

### SUMMARY

Embodiments of the present invention provide a method of producing a silica nanostructure, by which a silica nanostructure having a desired shape can be produced by easily controlling the shape of the nanostructure even if a liquid phase deposition (LPD) process is performed at low temperatures with a reduced production cost.

The above and other aspects of the present invention will be described in or be apparent from the following description of exemplary embodiments.

According to an aspect of the present invention, there is provided a method of producing silica nanostructures, the method including performing a LDP process including adding silica to a liquid phase deposition (LPD) solution and impregnating nano-sized silica beads aligned in a hexagonally closed packed lattice in the silica-added LPD solution, wherein shapes of the silica nanostructures are controlled by adjusting the concentration of silica based on the following expression:

0<W_{F}≦W_{S} (1).
where W_{F} is the content of silica added, and W_{S} is the content of silica required for the LPD solution to be saturated.

As described above, in the method of producing silica nanostructures according to an embodiment of the present invention, surfaces of the nanostructures are modified through LPD. The silica nanostructures can be easily controlled so as to provide desired shapes by simply changing the content of silica added. Accordingly, the silica nanostructures produced by a method according to an embodiment of the present invention can be used as a totally reflective coating material for preventing light from being reflected, and furthermore can be used as a substrate of a liquid crystal display.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A to 1D illustrate scanning electron microscopy (SEM) images showing changes in the shapes of nano-sized silica beads partially deposited over time, when the nano-sized silica beads aligned in a hexagonally closed packed lattice is reacted in a silica-saturated liquid phase deposition (LPD) solution. FIG. 1A illustrates an SEM image when the reaction time is 0 hour, FIG. 1B illustrates an SEM image when the reaction time is 0.5 hour, FIG. 10 illustrates an SEM image when the reaction time is 2 hours, and FIG. 1D illustrates an SEM image when the reaction time is 6 hours, the scale bar is 1 μm and that of the insets is 500 nm for each of FIGS. 1A to 1D.

FIGS. 2A to 2C illustrate atomic force microscopy (AFM) 3D images showing analysis results of surfaces of silica beads aligned in a hexagonally closed packed lattice through liquid phase deposition (LPD). Specifically, FIG. 2A illustrates an AFM image before LPD is performed on the silica beads and FIG. 2B illustrates an AFM image after 6 hours since LPD is performed on the silica beads. The inset shows a SEM image of the pinholes among the silica beads. The scale bar is 100 nm. FIG. 20 illustrates an AFM image of surface topography of an array of silica beads after LPD is performed, and FIGS. 2D and 2E are scanned profiles according to directions of r₁ and r₂ shown in FIG. 2C, respectively.

FIGS. 3A to 3D illustrates SEM images of nano-sized silica beads aligned in a hexagonally closed packed lattice. The SEM images show changes in shapes of the nano-sized silica beads etched and deposited over time. Specifically, when the nano-sized silica beads are reacted in an unsaturated LPD solution, FIG. 3A illustrates an SEM image when the reaction time is 0 hour, FIG. 3B illustrates an SEM image when the reaction time is 5 min, FIG. 30 illustrates an SEM image when the reaction time is 10 min, and FIG. 3D illustrates an SEM image when the reaction time is 30 min. In the respective drawings, white arrows and dotted circles indicate SiO₂ bridges, the scale bar is 1 μm and that of the insets is 500 nm for each of FIGS. 3A to 3D.

FIG. 4 illustrates the reaction mechanism depending on concentrations of the LPD solution.

FIGS. 5A to 5M illustrates SEM images showing changes in shapes of silica beads varying after interstitial LPD processes are performed, wherein the silica beads are not aligned in a hexagonally closed packed lattice. Specifically, FIG. 5A illustrates shapes of the silica beads obtained by performing local LPD process in a saturated LPD solution for 6 hours. In FIG. 5A, regions I and II indicate interstitial regions and closely packed regions of an array of silica beads, respectively, and white arrows indicate rectangular, pentagonal or irregular hexagonal shapes. In FIGS. 5B to 5M, white and red dotted lines indicate silica beads before and after LPD processes are performed, and the scale bar is 300 nm for each of FIGS. 5A to 5M.

### DETAILED DESCRIPTION

Hereinafter, examples of embodiments of the invention will be described in detail with reference to the accompanying drawings. The present invention may, however, be embodied in many different forms and should not be construed as being limited to the embodiments set forth herein. The term “room temperature” used herein means 15° C. to 25° C.

According to an embodiment of the present invention, the method of producing silica nanostructures includes performing low-temperature liquid phase deposition (LPD) including adding silica to a liquid phase deposition (LPD) solution and impregnating silica beads in the silica-added LPD solution, wherein shapes of the silica nanostructures are controlled by adjusting the concentration of the silica based on the following expression:

0<W_{F}≦W_{S} (1)
where W_{F} is the content of silica added, and W_{S} is the content of silica required for the LPD solution to be saturated.

According to an embodiment of the present invention, the silica beads are nano-sized silica beads fixed on a substrate. The silica beads may be arranged to be spaced apart from each other or to be closely packed. According to an embodiment of the present invention, the silica beads silica beads are nano- to micro-sized hexagonally closed packed and are preferably nano-sized hexagonally closed packed (HCP) silica beads.

The silica beads may be fixed on a substrate through a material layer formed by spin coating, and the material layer may be, for example, a poly(methyl methacrylate) (PMMA) layer. For example, the silica nano beads are aligned in various orientations on the substrate including the PMMA layer to then be subjected to heat treatment to make the PMMA layer soft, thereby fixing the silica nano beads thereon. For example, the heat treatment may be performed at a temperature in the range of 150° C. to 200° C.

The silica may be added while adjusting the concentration of silica added based on the expression (1) and shapes of the silica nanostructures produced may vary according to the change in the concentration of silica added. This is obtained from the finding that formation of SiO₂ is controlled by the concentration of Si(OH)₄ based on the following expression (2):

H₂SiF₆+SiO₂+6H₂O [symbol] 2Si(OH)₄+6HF (2)

That is to say, since under the condition of W_{F}=0, the concentration of H₂SiF₆ is much higher than that of the silica-added LPD solution (W_{F}>0), the hydrolysis speed of SiO₂ is increased. Accordingly, the etching reaction of silica beads is rapidly performed, so that the silica beads may vanish.

On the other hand, under the condition of 0<W_{F}<W_{S}, that is, in an unsaturated LPD solution, silica beads serve as the SiO₂ source with silica added and thus the etching reaction of silica beads occurs. However, the concentration of Si(OH)₄ in vicinity of the silica bead array is locally increased, in particular, at locations where the silica beads are brought into contact with neighboring silica beads, so that SiO₂ is locally deposited, thereby establishing bridges between neighboring silica beads. Therefore, etching or deposition predominantly takes place according to the content of silica added.

Meanwhile, deposition predominantly takes place under the condition of W_{F}=W_{S}, that is, in a saturated LPD solution. In particular, since deposition is limited due to presence of neighboring silica beads, SiO₂ is predominantly deposited on pinholes, and sizes of the pinholes are gradually reduced so as to be barely visible according to the progress of the reaction. The spherical silica beads may become angular and may ultimately have polygonal shapes. Here, the polygonal shapes of the silica beads may turn into rectangular, pentagonal or hexagonal shapes according to the packing density and alignment of silica beads.

According to an embodiment of the present invention, the LPD may be performed at a temperature in the range of room temperature to 50° C.

Hereinafter, the present invention will be described in more detail through examples.

### Chemical Materials Used

98% tetraethyl orthosilicate (TEOS), 28% ammonium hydroxide (NH₄OH) and 35% hexafluorosilicic acid (H₂SiF₆) were purchased from Sigma-Aldrich Corporation. Poly(methylmethacrylate)(PMMA) C2 was purchased from K1 Solution, Co., Ltd., and 99% ethanol and isopropyl alcohol (IPA) and fumigated silica were purchased from Ducksan Co., Ltd. A 300 nm thick Si(100) substrate having a SiO₂ layer was purchased from LG Siltron Co., Ltd.

### EXAMPLE 1

### <Synthesis of Spherical Silica Beads>

Spherical silica beads were synthesized by a Stober process using hydrolysis of TEOS in ethanol in the presence of NH₃ as a catalyst. 2.7 mL of 28% ammonium hydroxide (NH₄OH) and 70 mL of 99% ethanol were added to a glass flask and stirred. After the solution was stabilized, 3.1 mL of TEOS was added to the resultant solution and stirred, followed by hydrolysis and condensation. Next, a silica suspension was centrifuged and repeatedly re-dispersed using pure ethanol three or four times for washing.

### <Assembly of Spherical Silica Beads>

A 300-nm-thick SiO₂ layered silicon (Si) wafer was washed with IPA and spin-coated with PMMA to then be placed into an oxygen plasma cleaner (Harrick plasma cleaner PDC-32G), thereby preparing a hydrophilic PMMA surface. The spherical silica beads were assembled on the PMMA layer using a Langmuir-Blodgett assembly process, in which a solid substrate was impregnated in a liquid and a solid substance was deposited from the liquid surface to obtain a large-scale single layer array on the substrate. Here, the single layer array of the spherical silica beads was aligned in a hexagonally closed packed lattice due to surface tension.

### <LPD of Silica Beads in Hexagonally Closed Packed Lattice>

The substrate having silica beads aligned in a hexagonally closed packed lattice was heated at 200° C. for 2 minutes to soften PMMA and to fix the silica beads on a PMMA layer. Meanwhile, a liquid phase deposition (LPD) solution was prepared in the following manner. First, 110 mL of hexafluorosilicic acid was mixed with fumigated silica (SiO₂) powder having content varying in the range of 0 to 5 g and stirred at 400 rpm overnight. Next, deionized (DI) water was added to the resultant solution in a ratio of 1:2. As soon as the solution was prepared, samples were impregnated in the solution for various durations of time. After the LPD reaction was completed, the samples were washed with Dl water, followed by drying with blowing treatment using N₂ gas.

### EXPERIMENTAL EXAMPLE

The surface roughness and average height of the silica bead array were confirmed by atomic force microscope (AFM) (Park System, NX-10 model) and experiments were carried out in a noncontact mode. The scanning range and speed were 2×2 μm2 and 0.5 Hz, respectively. The surface topography of the silica bead array was investigated at an accelerated voltage of 15 kV by field-emission scanning electron microscopy (FE-SEM; JEOL JSM-760F). Prior to measurement by FE-SEM, the samples were coated with platinum.

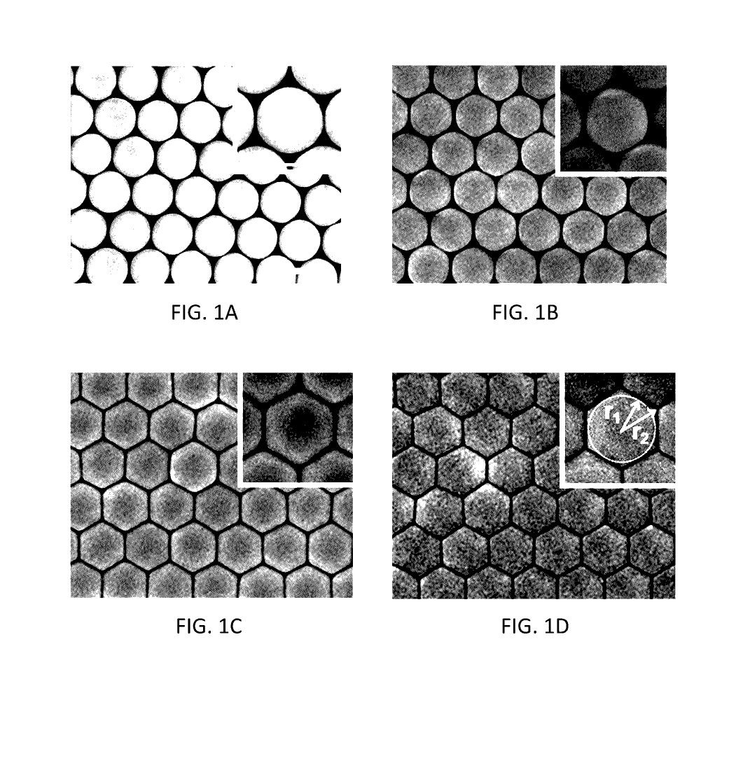

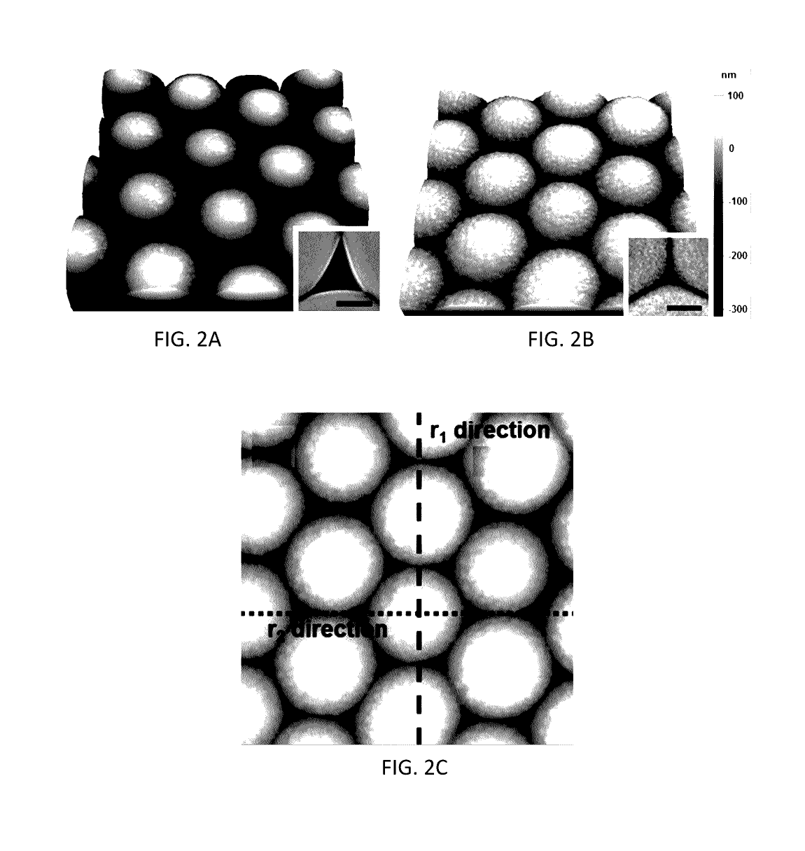

FIGS. 1A to 1D illustrate scanning electron microscopy (SEM) images showing the surface topography of an array of silica beads, measured by adding 5 g of silica to a (saturated) LPD solution while varying the reaction time. In FIG. 1A, r₁ and r₂ are distances ranging from the center of each of silica beads to each of neighboring silica beads and pinholes. Since deposition performed in the r₁ direction is restricted by neighboring silica beads, the deposition is directed to only the pinholes in the r₂ direction. Therefore, r₁ is equal to the radius (r₀) of each of the silica beads and has a constant value. However, r₂ is continuously increased up to (2/v3)r₀ until the pinhole between silica beads cannot be further reduced. Since the angle between r₁ and r₂ was 30°, and r₁ and r₂ were spaced at an interval of 60° with respect to the silica bead array aligned in the hexagonally dosed packed lattice, anisotropic topography of the closely packed silica beads was obtained. According to the progress of the reaction, sizes of pinholes were gradually reduced so as not to be visible and the spherical silica beads turned into angular silica beads to then ultimately become hexagonal silica beads after 6 hours through a local LPD process taking place on the nanostructure surface (see FIG. 1D.).

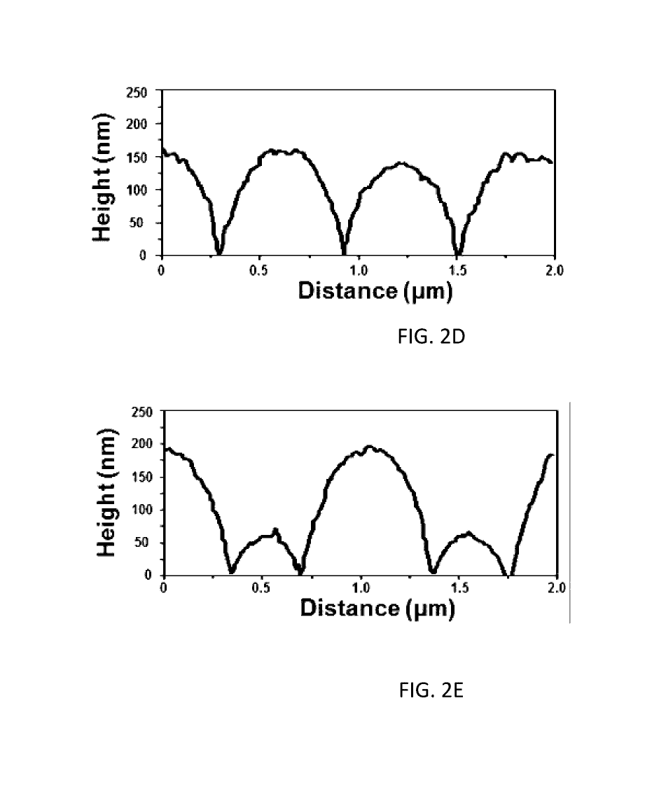

The surface roughness of the silica beads in the closed packed silicon bead array and the average height between peaks and valleys in the silica bead array were 13.25 and 197.80 nm, respectively, (see FIG. 2A.). After LPD took place for 6 hours in the LPD solution with 5 g of silica added thereto, the pinholes between silica beads were filled and the surface roughness and the average height were 13.73 and 149.18 nm, respectively (see FIG. 2B.).

After the LPD is finished, Si(OH)₄ was adsorbed into surfaces of silica beads while the surface roughness of the silica beads was almost constantly maintained during the 6-hour LPD process, which strongly suggests that coating performance was superb. However, the LPD process reduces the average height between the peak and valleys of the silica bead array.

In order to investigate the correlation between local LPD and topography in the hexagonally closed packed lattice silica bead array, line scanned profiles were measured from AFM 2D images obtained from the 6-hour LPD process performed in the r₁ and r₂ directions. FIG. 2D shows a line scanned profile in the r₁ direction, suggesting that the surface topography was maintained after the LPD was performed. However, as confirmed from the scanned profile measured in the r₂ direction, small or large bumps were observed from the silica beads and their neighboring areas. The average value of difference between heights of the bumps was 142 nm, which is similar to the value of the scanned profile measured in the r₁ direction. The results prove that deposition of SiO₂ during LPD locally takes place on lateral surfaces of silica beads including pinholes, rather than on top surfaces of silica beads.

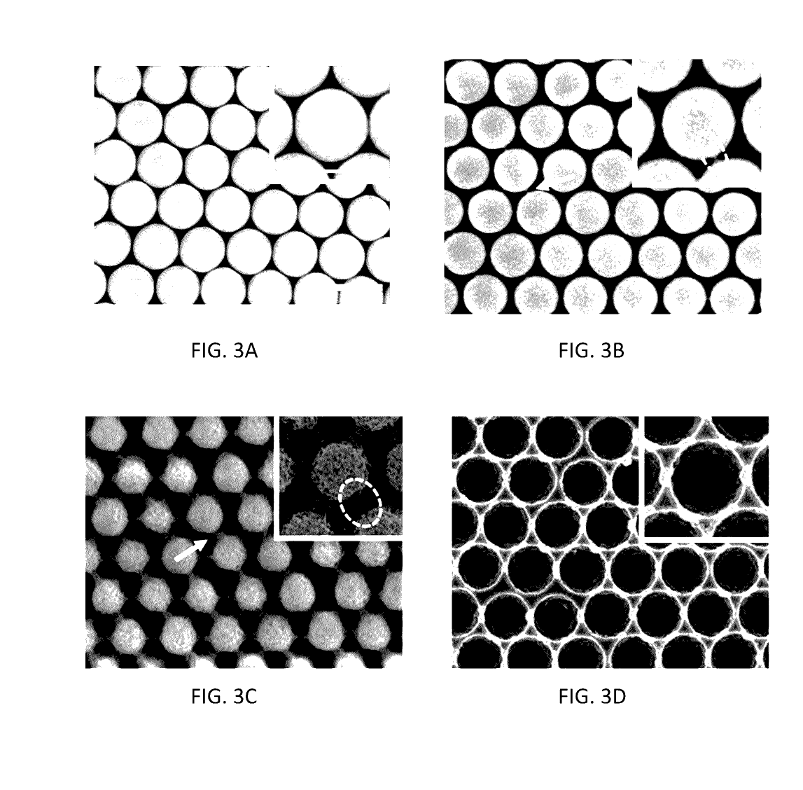

However, the LPD(SiO₂ deposition) performed in an unsaturated LPD solution (0<W_{F}<W_{S}) is differently performed from that performed in the saturated LPD solution. 2 g of silica was dissolved in the LPD solution and shape changes in the hexagonally closed packed lattice silica beads were monitored over time. The silica beads serve as SiO₂ sources together with silica due to insufficient content of silica compared to W_{S}, and etching of the silica beads predominantly takes place. According to the progress of the etching, sizes of the silica beads are gradually reduced and the concentration of Si(OH)₄ is locally increased at neighboring areas in the silica bead array, particularly at locations where the silica beads are brought into contact with their neighboring silica beads. Therefore, local distribution of Si(OH)₄ causes local deposition of SiO₂, thereby establishing branched structures in 5 minutes after the reaction.(see FIG. 3B.).

According to the progress of the reaction, the SiO₂ branches are lengthened until the average length of the SiO₂ branches is changed from 32.6 nm to 108.2 nm (see FIGS. 3B and 3C.). Even if local deposition takes place in the SiO₂ branches, the etching of silica beads is continuously performed according to the reaction time, and thus the SiO₂ branches were observed for 15 minutes after forming the SiO₂ branches. Next, the branches and the silica beads were etched away to then completely vanish, leaving only the PMMA layer (see FIG. 3D.). This suggests that both of deposition and etching locally exist and compete with each other.

In absence of silica added, condensation speeds were rapidly lowered when pH<7, while hydrolysis speeds were rapidly increased. Based on the expression (2), the concentration of H₂SiF₆ is much higher than that of the silica-added LPD solution (W_{F}>0), which increased the hydrolysis speed of SiO₂. Accordingly, the etching of silica beads was rapidly performed, and the silica beads almost vanished after 1 minute.

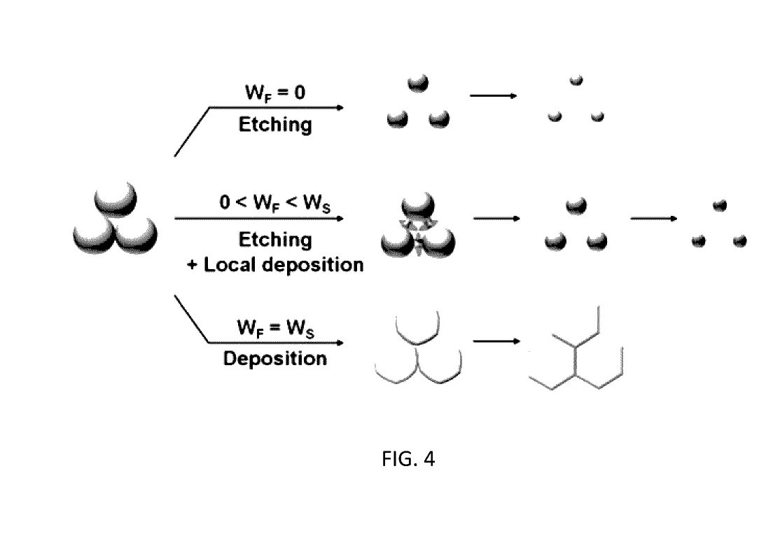

This phenomenon shows that the LPD is considerably affected by the composition of the LPD solution on nanostructure surfaces. FIG. 4 illustrates the LPD reaction mechanism associated with the composition of the LPD solution, which is controlled by the content of silica (W_{F}) added. When no silica is added (W_{F}=0), etching predominantly takes place and silica beads completely vanish. If an insufficient amount of silica is added to the LPD solution (0<W_{F}<W_{S}), not only etching of silica beads but deposition of SiO₂ bridges locally take place and the etching and the deposition are competitively performed. The local deposition takes place due to local distribution of Si(OH)₄, which is caused by the etching of the hexagonally closed packed lattice silica bead array. However, since the etching predominantly takes place, the silica beads and bridges were completely etched. When W_{F}=W_{S}, deposition predominantly takes place and the spherical silica beads anisotropically grow to turn into hexagonal silica beads, which is because Si(OH)₄ is abundantly supplied to the LPD solution based on the expression (2).

The shape difference in the hexagonally closed packed lattice silica bead array is caused by different concentrations of Si(OH)₄ on the nanostructure surfaces. However, in the nanostructures, non-uniform surfaces are caused by different topographies and this topographical signals change concentrations of reaction materials of different locations. In such a manner, local LPD is performed on the hexagonally closed packed lattice silica bead array. In addition, H₂SiF₆ with silica and silica beads may serve as etching reagent with the lapse of reaction time. Therefore, if H₂SiF₆ is not sufficiently saturated by silica, it may dissolve silica beads, instead of silica.

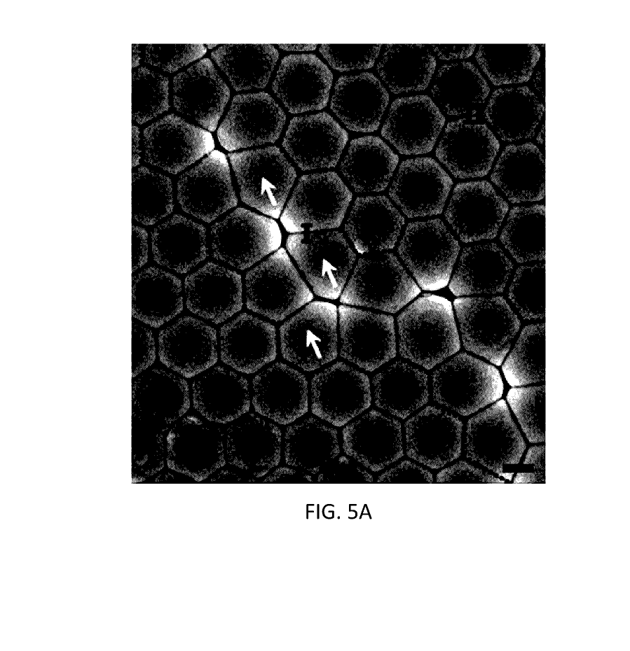

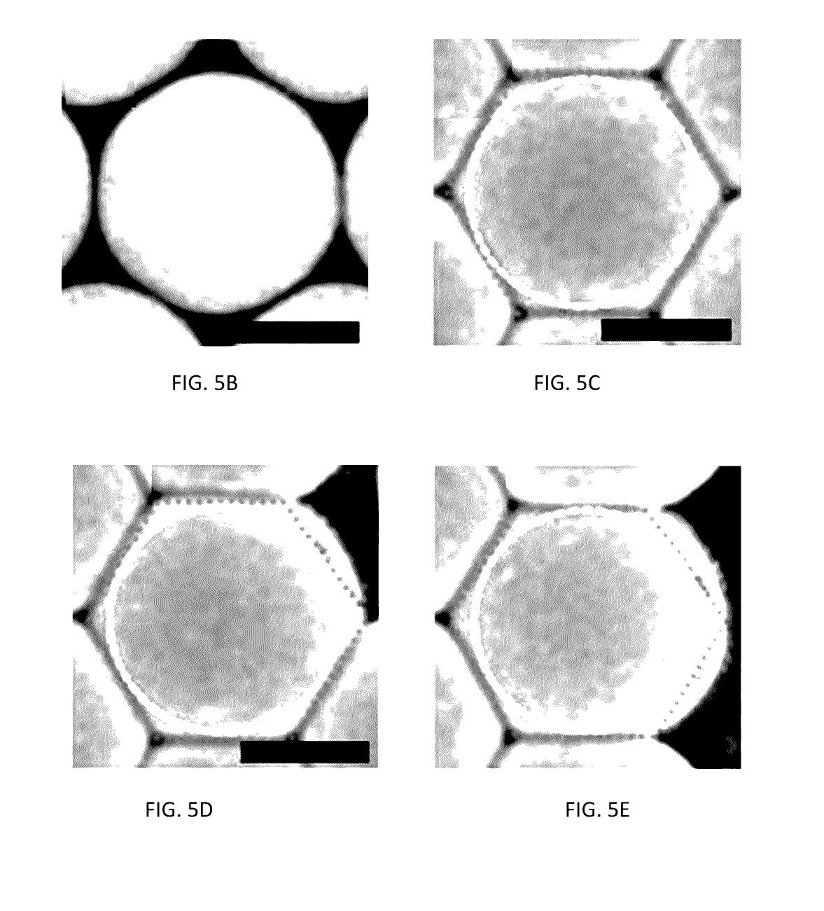

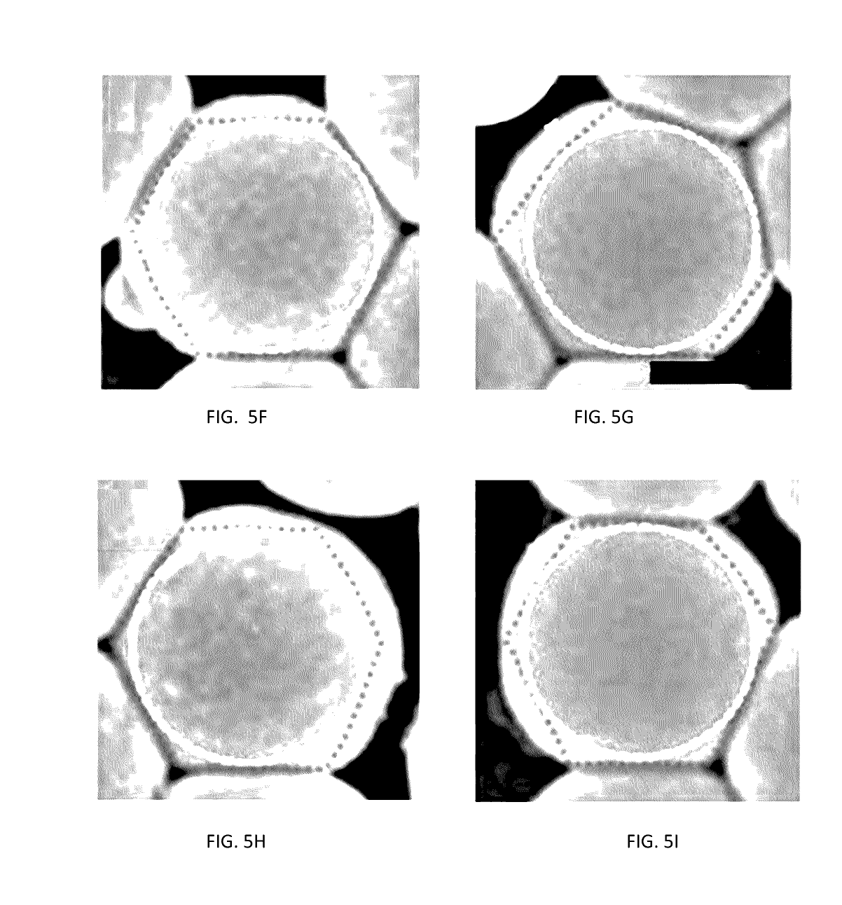

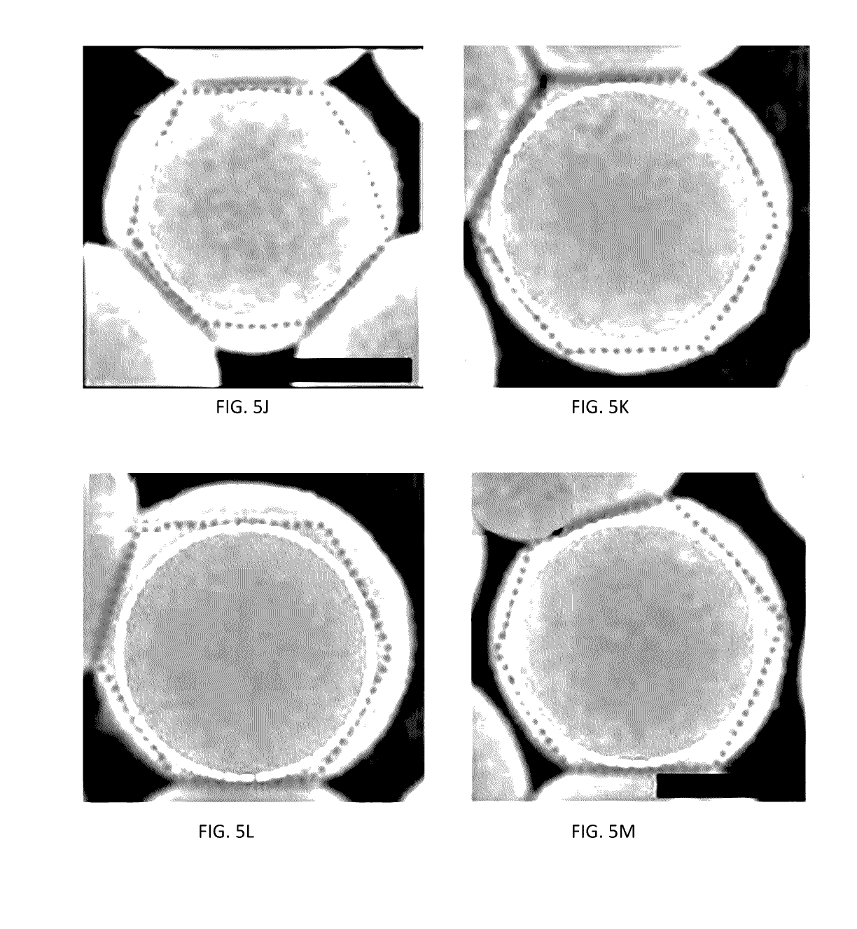

When the local LPD takes place in the saturated LPD solution (W_{F}=W_{S}), many distinguishable shapes of silica beads were observed from empty boundaries of the silica bead array and their neighboring silica beads (see FIGS. 5A to 5M.). Unlike the perfect silica beads array (region II of FIG. 5A, many unique shapes of silica beads exist at boundaries of the silica bead array. The unique shapes may include rectangles, pentagons, and other irregular hexagons (region I of FIG. 5A). Deposition of silica beads near empty regions is differently performed from local deposition of SiO₂ in silica beads surrounded by 6 neighboring silica beads (see FIG. 5C) and is accelerated toward the empty regions. Therefore, the spherical silica beads were changed into other polygonal silica beads, rather than the hexagonal silica beads, according to the number and locations of empty regions in the silica bead array (see FIGS. 5D to 5M.). The unique shapes of the silica beads cannot be attained by the conventional process. However, the method of producing silica nanostructures according to the present invention can be used in producing building blocks of silica nanostructures in various shapes.

While the a method of producing a silica nanostructure of the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of producing silica nanostructures, the method comprising performing low-temperature liquid phase deposition (LPD) including adding silica to a liquid phase deposition (LPD) solution and impregnating silica beads in the silica-added LPD solution,
wherein shapes of as-produced silica nanostructures are controlled by adjusting the added amount of silica on the following expression:
0<W_{F}≦W_{S} (1)
where W_{F} is the content of silica added, and W_{S} is the content of silica required for the LPD solution to be saturated.

2. The method of claim 1, wherein the silica beads impregnated in the silica-added LPD solution have various sizes and are aligned on a substrate in various orientations.

3. The method of claim 1, wherein the silica beads are nano- to micro-sized hexagonally closed packed (HCP) silica beads.

4. The method of claim 1, wherein the silica nanostructures are bridged therebetween.

5. The method of claim 1, wherein the shapes of the silica nanostructures are a rectangular lattice, a pentagonal lattice, a hexagonal lattice or a polygonal lattice.

6. The method of claim 1, wherein the liquid deposition process is performed at a temperature ranging from room temperature to 50° C.
